(19) United States
(12) Patent Application Publication
(10) Pub. No.: US 2025/0355115 A1
(43) Pub. Date: Nov. 20, 2025

(54) PHOTOSENSOR DRIVING DEVICE AND PRINTER

(71) Applicant: FCL COMPONENTS LIMITED, Tokyo (JP)

(72) Inventor: Taichi SAKAKURA, Tokyo (JP)

(73) Assignee: FCL COMPONENTS LIMITED, Tokyo (JP)

(21) Appl. No.: 19/027,070

(22) Filed: Jan. 17, 2025

(30) Foreign Application Priority Data
May 16, 2024 (JP) 2024-080379

(51) Int. Cl. G01S 17/04; B41J 11/00

(52) U.S. Cl. CPC G01S 17/04; B41J 11/0095

(57) ABSTRACT

A photosensor driving device includes a plurality of photosensors each having a light emitting element and a light receiving element, and a controller that including an output port commonly connected to light emitting elements of the plurality of photosensors, and a plurality of input ports connected to light receiving elements of the plurality of photosensors, respectively, wherein the controller outputs signals having duty ratios corresponding to the plurality of photosensors to the light emitting elements in order through the output port, respectively, and the controller inhibits an input from a photosensor as a non-detection target in the plurality of photosensors during a period in which the signals are output, and inputs, via the input port, an output of the light receiving element obtained by light emission of the light emitting element in another photosensor as a detection target in the plurality of photosensors.

### CROSS-REFERENCE TO RELATED APPLICATION

This application is based upon and claims the benefit of priority of the prior Japanese Patent Application No. 2024-080379 filed on May 16, 2024, the entire contents of which are incorporated herein by reference.

### FIELD

A certain aspect of the embodiments is related to a photosensor driving device and a printer.

### BACKGROUND

There have been conventionally known a technique of using a photosensor as a means for detecting a sheet in a printer or a black mark on the sheet and a technique of controlling a light-emitting current of the photosensor by a PWM (Pulse Width Modulation) method (for example, Patent Document 1: Japanese Laid-Open Patent Publication No. 2007-248182, and Patent Document 2: Japanese Laid-Open Patent Publication No. 2006-114324).

### SUMMARY

According to an aspect of the present disclosure, there is provided a photosensor driving device including: a plurality of photosensors each having a light emitting element and a light receiving element; and a controller that including: an output port commonly connected to light emitting elements of the plurality of photosensors; and a plurality of input ports connected to light receiving elements of the plurality of photosensors, respectively; wherein the controller outputs signals having duty ratios corresponding to the plurality of photosensors to the light emitting elements in order through the output port, respectively, and the controller inhibits an input from a photosensor as a non-detection target in the plurality of photosensors during a period in which the signals are output, and inputs, via the input port, an output of the light receiving element obtained by light emission of the light emitting element in another photosensor as a detection target in the plurality of photosensors.

According to an aspect of the present disclosure, there is provided a photosensor driving device including: a plurality of photosensors each having a light emitting element and a light receiving element; and a controller that including: a plurality of output ports connected to light emitting elements of the plurality of photosensors, respectively; and an input port commonly connected to light receiving elements of the plurality of photosensors; wherein the controller outputs signals having duty ratios corresponding to the plurality of photosensors to the light emitting elements in order through the plurality of output ports, respectively, and the controller receives data input from the input port during a period in which the signals are output as an output of a photosensor as a detection target in the plurality of photosensors.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a printer including a photosensor driving device according to a first embodiment.

FIG. 2 is a block diagram of the photosensor driving device according to the first embodiment.

FIG. 3 is a diagram illustrating a relationship between signals output from the MCU and outputs from the plurality of photosensors.

FIG. 4A is a diagram illustrating a relationship between output voltages of the plurality of photosensors and output reading timings when the plurality of photosensors are switched and power is supplied in order.

FIG. 4B is a diagram illustrating a relationship between output voltages of the plurality of photosensors and output reading timings when the power is constantly supplied to the plurality of photosensors.

FIG. 5 is a flowchart illustrating a process of adjusting a duty ratio.

FIG. 6 is a block diagram of a photosensor driving device according to a second embodiment.

FIG. 7 is a diagram illustrating a relationship between signals output from the MCU and outputs from the plurality of photosensors.

FIG. 8 is a block diagram of a photosensor driving device according to a modification of the second embodiment.

### DESCRIPTION OF EMBODIMENTS

Hereinafter, a description will be given of the embodiment of the present disclosure with reference to the drawings.

When a plurality of photosensors are used, a micro controller unit (MCU) is connected to the plurality of photosensors, and needs to have an output port for outputting a signal to each photosensor and an input port for inputting an output value of each photosensor. Therefore, as the number of the plurality of photosensors to be used increases, the number of the output ports and the number of the input ports required for the MCU increase, which may strain the resources of the MCU. This may also force the selection of a relatively expensive MCU with a large number of ports.

It is an object of the present disclosure to provide a photosensor drive device and a printer which can reduce the number of ports required for a controller when a plurality of photosensors are used.

### First Embodiment

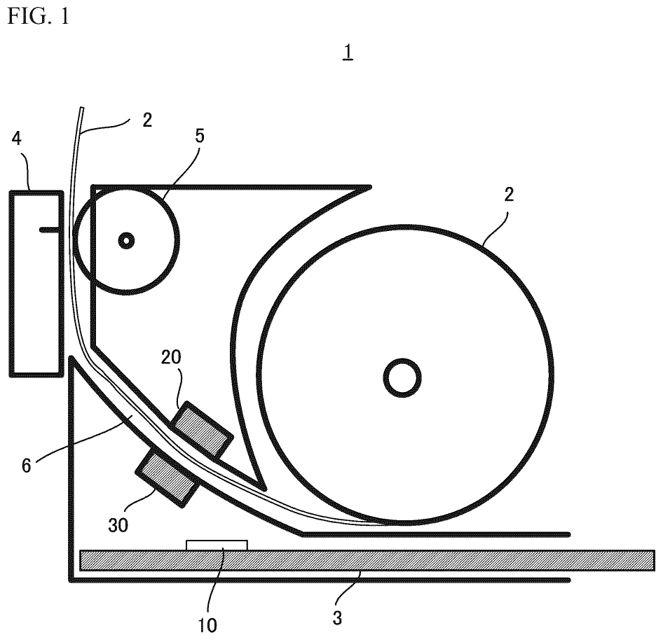

FIG. 1 is a block diagram of a printer including a photosensor driving device according to a first embodiment. A printer 1 is, for example, a thermal printer for printing on a roll paper 2, but may be an ink jet printer or a laser printer, and the type of printer is not limited.

The printer 1 includes a control substrate 3, a thermal head 4, a platen roller 5, a conveying path 6, and photosensors 20 and 30 (a first photosensor and a second photosensor). The control substrate 3 includes a micro controller unit (MCU) 10 serving as a controller that controls the operation of the entire printer 1. The MCU10 is electrically connected to the thermal head 4, the photosensors 20 and 30, and a motor (not illustrated) for conveying the roll paper 2.

The thermal head 4 is a component for printing by reacting a thermally reactive material of the roll paper 2 (thermal paper) with Joule heat generated by energization. The platen roller 5 is a roller used as a component for feeding paper and pressing the paper against the thermal head 4. The conveying path 6 is a path for conveying the roll paper 2. The photosensor 20 is a sensor for reading a mark on the back surface (i.e., a surface opposite to a printing surface) of the roll paper 2, and the photosensor 30 is a sensor for reading a mark on the front surface (i.e., the printing surface) of the roll paper 2 and detecting the presence or absence of the roll paper 2.

The photosensors 20 and 30 are, for example, reflection photosensors, but may be transmission photosensors. In the example of FIG. 1, the photosensors 20 and 30 are reflective photosensors and are thus disposed so as to face the roll paper 2. Although the photosensors 20 and 30 are opposed to each other with the conveying path 6 therebetween, the arrangement of the photosensors 20 and 30 is not limited to the example illustrated in FIG. 1. The printer 1 may include three or more photosensors.

When transmission type photosensors are used as the photosensors 20 and 30, the photosensors 20 and 30 are arranged in the conveying path 6 so that the roll paper passes between the light emitting element and the light receiving element of each of the photosensors 20 and 30.

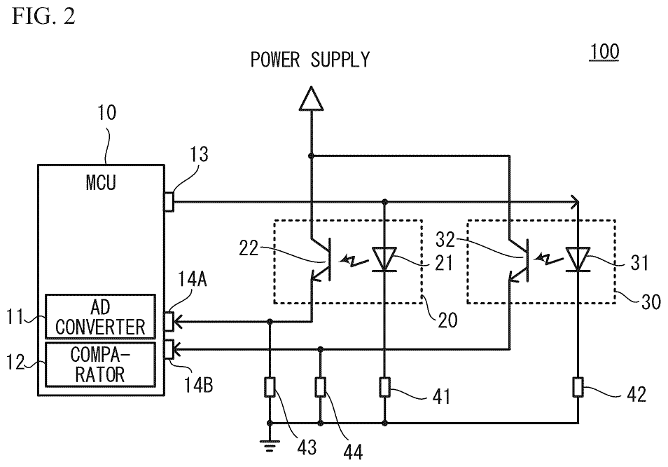

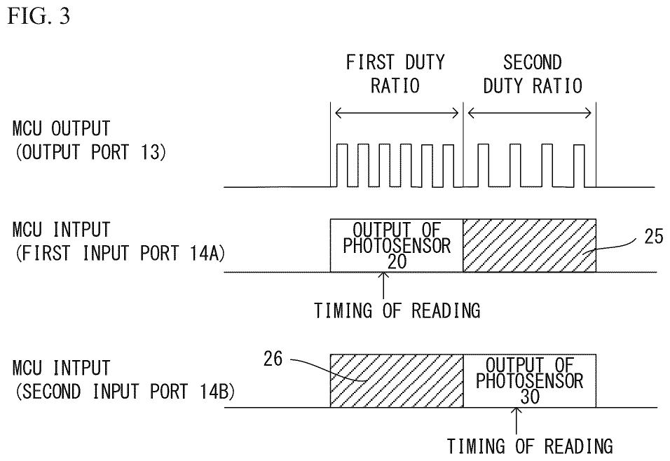

FIG. 2 is a block diagram of the photosensor driving device according to the first embodiment. FIG. 3 is a diagram illustrating a relationship between signals output from the MCU 10 and outputs from the photosensors 20 and 30. In FIG. 3, a hatched portion 25 indicates that the MCU 10 prohibits the input of the output voltage from the photosensor 20, and a hatched portion 26 indicates that the MCU 10 prohibits the input of the output voltage from the photosensor 30.

As illustrated in FIG. 2, a photosensor driving device 100 according to the first embodiment includes the MCU 10, the photosensors 20 and 30, light-emitting current adjusting resistors 41 and 42, and sensor output detecting resistors 43 and 44. The MCU 10, the light-emitting current adjusting resistors 41 and 42, and the sensor output detecting resistors 43 and 44 are mounted on the control substrate 3 illustrated in FIG. 1. The MCU 10 includes an AD converter 11, a comparator 12, an output port 13, a first input port 14A, and a second input port 14B. The photosensor 20 includes an LED 21 (a first light emitting element) and a phototransistor 22 (a first light receiving element). The photosensor 30 includes an LED 31 (a second light emitting element) and a phototransistor 32 (a second light receiving element).

A power supply for supplying power to the photosensors 20 and 30 is connected to the collectors of the phototransistors 22 and 32. The emitter of the phototransistor 22 is connected to the first input port 14A and one end of the sensor output detecting resistor 43. The emitter of the phototransistor 32 is connected to the second input port 14B and one end of the sensor output detecting resistor 44. The other ends of the sensor output detecting resistors 43 and 44 are connected to the ground i.e., are grounded.

The output port 13 is connected to the anodes of the LEDs 21 and 31. The cathode of the LED 21 is connected to one end of the light-emitting current adjusting resistor 41, and the other end of the light-emitting current adjusting resistor 41 is grounded. The cathode of the LED 31 is connected to one end of the light-emitting current adjusting resistor 42, and the other end of the light-emitting current adjusting resistor 42 is grounded.

The light-emitting current adjusting resistors 41 and 42 are resistors for adjusting currents flowing through the LEDs 21 and 31, respectively, in other words, resistors for adjusting the light-emitting intensities of the LEDs 21 and 31. When the resistance values of the light-emitting current adjusting resistors 41 and 42 reduce, the currents flowing through the LEDs 21 and 31 increase, and the light-emitting intensities of the LEDs 21 and 31 increase. When the resistance values of the light-emitting current adjusting resistors 41 and 42 increase, the currents flowing through the LEDs 21 and 31 reduce, and the light-emitting intensities of the LEDs 21 and 31 reduce.

The sensor output detecting resistors 43 and 44 convert currents flowing between the collectors and the emitters of the phototransistors 22 and 32 into voltages, respectively, and input the voltages to the AD converter 11. In other words, the sensor output detecting resistors 43 and 44 are resistors for adjusting the detection sensitivities with respect to the output currents of the phototransistors 22 and 32. When the resistance values of the sensor output detecting resistors 43 and 44 are reduced, the voltage input to the AD converter 11 is reduced.

Power consumption can be suppressed by setting the resistance values of the sensor output detecting resistors 43 and 44 and the resistance values of the light-emitting current adjusting resistors 41 and 42 to be large within a range not exceeding the characteristics of the photosensors 20 and 30, that is, within a range in which the currents flowing through the LEDs 21 and 31 and the currents flowing between the collectors and emitters of the phototransistors 22 and 32 do not exceed the values described in the data sheets of the photosensors 20 and 30.

As illustrated in FIG. 3, the MCU 10 sequentially outputs a first signal having a first duty ratio and a second signal having a second duty ratio to the photosensors 20 and 30 through the output port 13, respectively. The first signal having the first duty ratio is a pulse width modulation (PWM) signal for controlling the current flowing through the photosensor 20, and the second signal having the second duty ratio is a PWM signal for controlling the current flowing through the photosensor 30. Since the first duty ratio and the second duty ratio are used to adjust the outputs of the photosensors 20 and 30, respectively, the first duty ratio and the second duty ratio may be the same as or different from each other. Although FIG. 3 illustrates an example in which the first duty ratio is larger than the second duty ratio, the first duty ratio may be smaller than the second duty ratio.

The LEDs 21 and 31 emit light when receiving the first signal having the first duty ratio. In the phototransistor 22, a current (photocurrent) corresponding to incident light from the LED21 becomes a base current of the phototransistor 22, and an output current flows between the collector and the emitter of the phototransistor 22. The output voltage of the photosensor 20 generated by the current flowing through the sensor output detecting resistor 43 is input to the first input port 14A. In the phototransistor 32, a current (photocurrent) corresponding to the incident light from the LED31 becomes a base current of the phototransistor 32, and an output current flows between the collector and the emitter of the phototransistor 32. The output voltage of the photosensor 30 generated by the current flowing through the sensor output detecting resistor 44 is input to the second input port 14B.

The AD converter 11 of the MCU10 performs AD conversion on the output voltages of the photosensors 20 and 30. The comparator 12 compares the output voltages of the photosensors 20 and 30 after the AD conversion with a predetermined threshold value, and detects the presence or absence of the sheet and the black mark in accordance with whether or not the output voltage of the photosensor 20 after the AD conversion exceeds the predetermined threshold value. For example, when a white portion of the sheet is read, the output voltages of the photosensors 20 and 30 become high voltage values (values close to the power supply voltage), and when a black portion of the sheet or a part of the housing or the like is read without the sheet, the output voltages of the photosensors 20 and 30 become low voltage values (values close to 0 V). Therefore, the comparator 12 can detect the presence or absence of the sheet and the black mark in accordance with whether or not the output voltage of the photosensors 20 and 30 after AD conversion exceeds the predetermined threshold value.

As described above, when the MCU 10 outputs the first signal having the first duty ratio from the output port 13, the LEDs 21 and 31 emit light simultaneously. Since the first signal having the first duty ratio is a signal for controlling the current flowing through the photosensor 20, the output voltage of the photosensor 30 is not necessary.

Therefore, as illustrated in FIG. 3, the MCU 10 prohibits the input from the second input port 14B (see the hatch portion 26) during a period in which the first signal having the first duty ratio is output, and inputs the output voltage of the phototransistor 22 obtained by the light emission of the LED 21 through the first input port 14A. The MCU 10 may receive and discard the input from the second input port 14B during the period in which the first signal having the first duty ratio is output.

Similarly, when the MCU 10 outputs the second signal having the second duty ratio from the output port 13, the LEDs 21 and 31 emit light simultaneously. Since the second signal having the second duty ratio is a signal for controlling the current flowing through the photosensor 30, the output voltage of the photosensor 20 is not necessary.

Therefore, as illustrated in FIG. 3, the MCU 10 prohibits the input from the first input port 14A (see the hatch portion 25) during a period in which the second signal having the second duty ratio is output, and inputs the output voltage of the phototransistor 32 obtained by the light emission of the LED 31 through the second input port 14B. The MCU 10 may receive and discard the input from the first input port 14A during the period in which the second signal having the second duty ratio is output. As described above, since the input from the second input port 14B is inhibited during the period in which the first signal is output and the input from the first input port 14A is inhibited during the period in which the second signal is output, the plurality of photosensors can be appropriately controlled even if the MCU 10 is provided with only one output port connected to the plurality of photosensors.

As illustrated in FIG. 3, the timing of reading the output voltage of the photosensor 20 may be within the period in which the first signal having the first duty ratio is output. The output voltage of the photosensor 20 may be read a plurality of times during the period in which the first signal having the first duty ratio is output. For example, an average value of a plurality of readings may be adopted as the output voltage of the photosensor 20.

Similarly, the timing of reading the output voltage of the photosensor 30 may be within the period during which the second signal having the second duty ratio is output. The output voltage of the photosensor 30 may be read a plurality of times during the period in which the second signal having the second duty ratio is output. For example, an average value of a plurality of readings may be adopted as the output voltage of the photosensor 30.

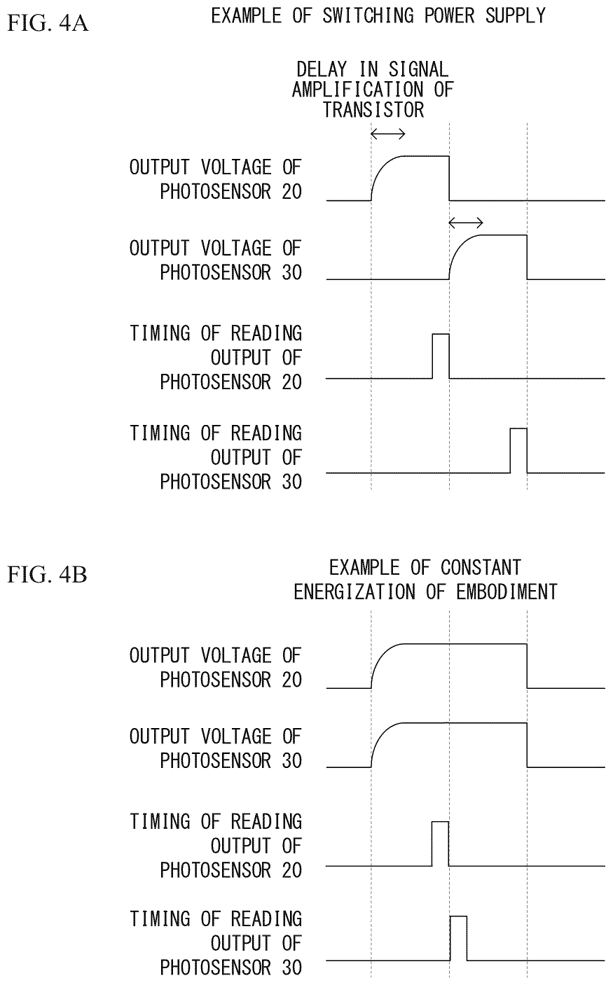

FIG. 4A is a diagram illustrating the relationship between the output voltages of the photosensors 20 and 30 and the output reading timings of the photosensors 20 and 30 when the LEDs 21 and 31 are connected to the individual output ports and switched in order. FIG. 4B is a diagram illustrating the relationship between the output voltages of the photosensors 20 and 30 and the output reading timings of the photosensors 20 and 30 when the outputs of the output port 13 are constantly supplied to the LEDs 21 and 31.

In FIG. 4A, the driving of the LED by the output port is switched from the LED 21 to the LED 31. In this case, it is necessary to wait for the rise of the output voltage of the photosensors 20 and 30 due to the delay in the signal amplification of the phototransistors 22 and 32. Since the output of the photosensor 20,30 is read after the output voltage of the photosensor 20 or 30 is stabilized, the timing of starting the reading of the photosensor 20 or 30 is delayed, and it is difficult to shorten the interval between the reading of the photosensor 20 and the reading of the photosensor 30.

In contrast, in the first embodiment, when the output voltages of the phototransistors 22 and 32, that is, the output voltages of the photosensors 20 and 30 are read, the LED 21 and the LED 31 are simultaneously energized. In this case, since the LED 21 and the LED 31 are not switched, as illustrated in FIG. 4 b, the reading of the photosensor 30 can be started at least at an earlier timing than in the case where the energization of the LEDs 21 and 31 is switched regardless of the delay in the signal amplification of the phototransistors 22 and 32. Therefore, the interval between the reading of the photosensor 20 and the reading of the photosensor 30 can be shortened, and the reading process by the photosensors 20 and 30 can be completed earlier than in the case where the energization of the LEDs 21 and 31 is switched. Further, since the reading of the photosensor 30 can be started at an early timing, the output voltage of the photosensor 30 can be read a plurality of times, and the average value of the read values can be adopted.

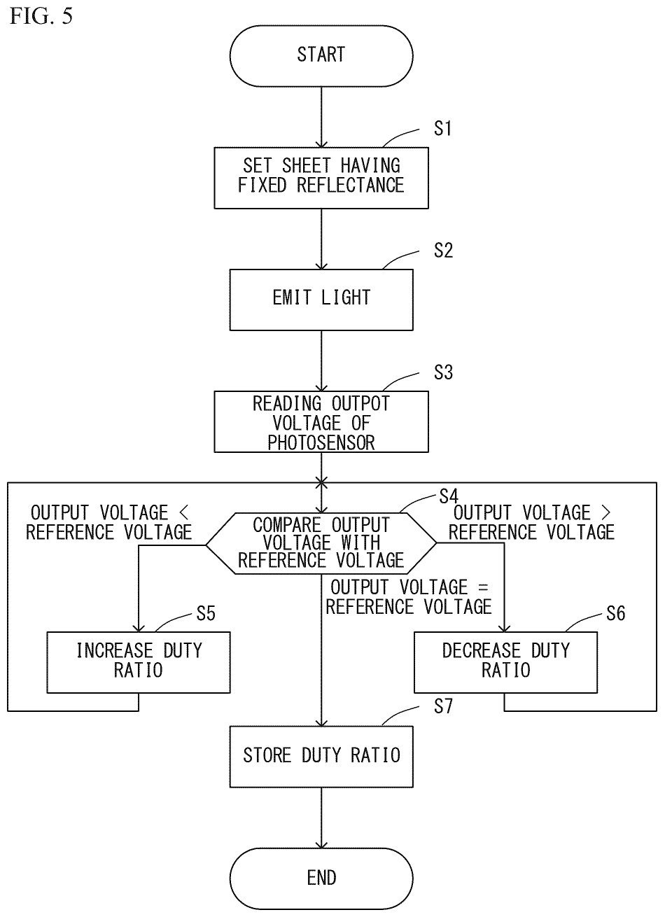

FIG. 5 is a flowchart illustrating the process of adjusting the duty ratio. Here, the first duty ratio and the second duty ratio are described as duty ratios.

First, a sheet having a fixed reflectance is set in the printer 1 (S1). Next, the MCU 10 causes the photosensors 20 and 30 to emit light (S2), and reads the output voltages of the photosensors 20 and 30 (S3). The MCU 10 compares the output voltages of the photosensors 20 and 30 with the reference voltages of the photosensors 20 and 30 (S4). The reference voltages of the photosensors 20 and 30 are values set in advance in the MCU 10.

If the output voltages of the photosensors 20 and 30 are lower than the reference voltages of the photosensors 20 and 30 in S4, the MCU 10 increases the duty ratio (S5), and the process of S5 is repeated until the output voltages of the photosensors 20 and 30 match the reference voltages of the photosensors 20 and 30.

If the output voltages of the photosensors 20 and 30 are higher than the reference voltages of the photosensors 20 and 30 in S4, the MCU 10 decreases the duty ratio (S6), and the process of S6 is repeated until the output voltages of the photosensors 20 and 30 match the reference voltages of the photosensors 20 and 30.

If the output voltages of the photosensors 20 and 30 match the reference voltages of the photosensors 20 and 30 in S4, the MCU 10 stores the duty ratio in a memory (not illustrated) in the MCU 10 (S7), and ends the process.

In this way, by adjusting the first duty ratio of the first signal and the second duty ratio of the second signal, the emission intensities of the LEDs 21 and 31 can be finely adjusted. In the photosensor driving device 100 according to the first embodiment, the emission intensities of the LEDs 21 and 31 are adjusted by the resistance values of the light-emitting current adjusting resistors 41 and 42, and the emission intensities of the LEDs 21 and 31 that cannot be adjusted by the resistance values of the light-emitting current adjusting resistors 41 and 42 are finely adjusted by the first duty ratio of the first signal and the second duty ratio of the second signal supplied to the LEDs 21 and 31.

According to the first embodiment, the MCU 10 outputs the first signal having the first duty ratio and the second signal having the second duty ratio to the photosensors 20 and 30 through one output port 13 in order. The MCU 10 prohibits the input from the second input port 14B during the period when the first signal is output, and inputs the output of the phototransistor 22 obtained by the emission of light from the LED 21 through the first input port 14A, and prohibits the input from the first input port 14A during the period when the second signal is output, and inputs the output of the phototransistor 32 obtained by the emission of light from the LED 31 through the second input port 14B.

Thus, the plurality of photosensors 20, 30 can be controlled by the first signal and the second signal sequentially output from one output port 13, and the outputs from the plurality of photosensors 20, 30 can be detected by the plurality of input ports 14A, 14B, respectively, so that the number of ports of the MCU 10 can be reduced when the plurality of photosensors 20, 30 are used. In addition, as the MCU 10, an inexpensive MCU having a small number of ports can be used.

### Second Embodiment

The second embodiment differs from the first embodiment in the number of output ports and the number of input ports of the MCU 10.

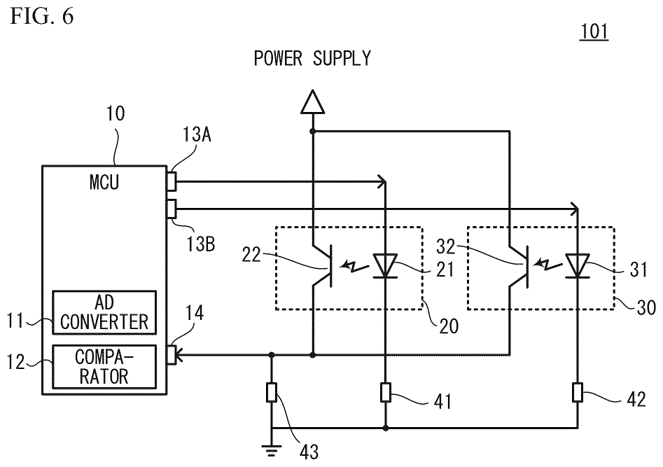

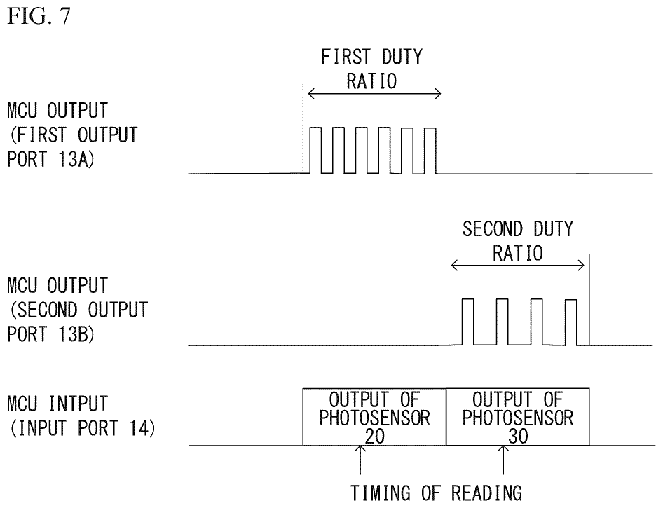

FIG. 6 is a block diagram of a photosensor driving device according to a second embodiment. FIG. 7 is a diagram illustrating a relationship between signals output from the MCU 10 and outputs from the photosensors 20 and 30.

As illustrated in FIG. 6, a photosensor driving device 101 according to the second embodiment includes the MCU 10, the photosensors 20 and 30, the light-emitting current adjusting resistors 41 and 42, and the sensor output detecting resistor 43. The MCU 10 includes the AD converter 11, the comparator 12, a first output port 13A, a second output port 13B, and an input port 14. The photosensors 20 and 30 of the second embodiment are the same as the photosensors 20 and 30 of the first embodiment. The processing and functions of the AD converter 11 and the comparator 12 of the MCU 10 of the second embodiment are the same as those of the AD converter 11 and the comparator 12 of the MCU 10 of the first embodiment.

A power supply for supplying voltages to the photosensors 20 and 30 is connected to the collectors of the phototransistors 22 and 32. The emitter of the phototransistor 22 is connected to the input port 14 and one end of the sensor output detecting resistor 43. The emitter of the phototransistor 32 is connected to the input port 14 and one end of the sensor output detecting resistor 43. The other end of the sensor output detecting resistor 43 is connected to ground.

The first output port 13A is connected to the anode of the LED 21. The cathode of the LED 21 is connected to one end of the light-emitting current adjusting resistor 41, and the other end of the light-emitting current adjusting resistor 41 is grounded. The second output port 13B is connected to the anode of the LED 31. The cathode of the LED 31 is connected to one end of the light-emitting current adjusting resistor 42, and the other end of the light-emitting current adjusting resistor 42 is grounded.

The light-emitting current adjusting resistors 41 and 42 of the second embodiment are the same as the light-emitting current adjusting resistors 41 and 42 of the first embodiment. The sensor output detecting resistor 43 of the second embodiment is the same as the sensor output detecting resistor 43 of the first embodiment.

The LED 21 emits light when receiving the first signal having the first duty ratio. In the phototransistor 22, a current (photocurrent) corresponding to incident light from the LED 21 becomes a base current of the phototransistor 22, and an output current flows between the collector and the emitter of the phototransistor 22. The output voltage of the photosensor 20 generated by the current flowing through the phototransistor 22 and the sensor output detecting resistor 43 is input to the input port 14.

The LED 31 emits light when receiving the second signal having the second duty ratio. In the phototransistor 32, a current (photocurrent) corresponding to the incident light from the LED 31 becomes a base current of the phototransistor 32, and an output current flows between the collector and the emitter of the phototransistor 32. The output voltage of the photosensor 30 generated by the current flowing through the phototransistor 32 and the sensor output detecting resistor 43 is input to the input port 14.

As illustrated in FIG. 7, the MCU 10 outputs the first signal having the first duty ratio to the photosensor 20 via the first output port 13A, and outputs the second signal having the second duty ratio to the photosensor 30 via the second output port 13B at a timing that does not overlap with the output period of the first signal. Since the period during which the first signal having the first duty ratio is output does not overlap the period during which the second signal having the second duty ratio is output, the MCU 10 can acquire the output voltages of the plurality of photosensors 20 and 30 through one input port 14. The first signal and the second signal of the second embodiment are PWM signals, and are the same as the first signal and the second signal of the first embodiment.

According to the second embodiment, the MCU 10 outputs the first signal having the first duty ratio and the second signal having the second duty ratio to the LEDs 21 and 31 through the first output port 13A and the second output port 13B, respectively. The MCU10 inputs the output of the phototransistor 22 obtained by the light emission of the LED 21 through the input port 14 during the period in which the first signal is output, and inputs the output of the phototransistor 32 obtained by the light emission of the LED 31 through the input port 14 during the period in which the second signal is output.

Thus, the plurality of photosensors 20, 30 can be controlled by the first signal and the second signal output from the plurality of output ports 13A, 13B, respectively, and the output from the plurality of photosensors 20, 30 can be detected by one input port 14, so that the number of ports of the MCU 10 can be reduced when the plurality of photosensors 20, 30 are used. In addition, as the MCU 10, an inexpensive MCU having a small number of ports can be used.

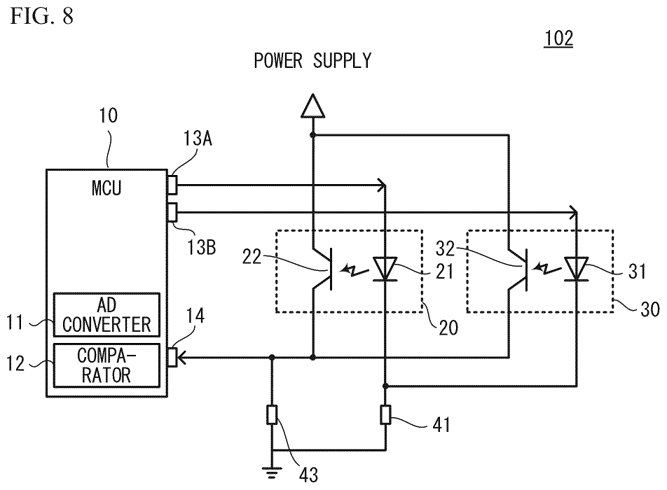

FIG. 8 is a block diagram of a photosensor driving device according to a modification of the second embodiment. A photosensor driving device 102 of FIG. 8 is different from the photosensor driving device 101 of FIG. 6 in that the two light-emitting current adjusting resistors 41 and 42 are combined into one light-emitting current adjusting resistor 41. The other configuration is the same as that of the photosensor driving device 101 illustrated in FIG. 6.

When the maximum values and the minimum values of the output current of the phototransistor 22 and the output current of the phototransistor 32 are included in the range of ±50% of the standard values of the output current predetermined as the characteristic of the phototransistor 22 and the characteristic of the phototransistor 32, respectively, the light-emitting current adjusting resistor connected between the LED 21 and the ground and another light-emitting current adjusting resistor connected between the LED 31 and the ground are shared by one light-emitting current adjusting resistor 41.

This eliminates the need to connect separate light-emitting current adjusting resistors between the LED 21 and the ground and between the LED 31 and the ground, thereby reducing the manufacturing cost of the photosensor driving device. The emission intensities of the LEDs 21 and 31, which cannot be adjusted by the resistance value of the light-emitting current adjusting resistor 41, can be finely adjusted by the first duty ratio of the first signal and the second duty ratio of the second signal.

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been 10 described in detail, it should be understood that the various changes, substitutions, and alterations could be made hereto without departing from the spirit and scope of the invention.

What is claimed is:

1. A photosensor driving device comprising:
a plurality of photosensors each having a light emitting element and a light receiving element; and
a controller that including:
an output port commonly connected to light emitting elements of the plurality of photosensors; and
a plurality of input ports connected to light receiving elements of the plurality of photosensors, respectively;
wherein the controller outputs signals having duty ratios corresponding to the plurality of photosensors to the light emitting elements in order through the output port, respectively, and
the controller inhibits an input from a photosensor as a non-detection target in the plurality of photosensors during a period in which the signals are output, and inputs, via the input port, an output of the light receiving element obtained by light emission of the light emitting element in another photosensor as a detection target in the plurality of photosensors.

2. A photosensor driving device comprising:
a plurality of photosensors each having a light emitting element and a light receiving element; and
a controller that including:
a plurality of output ports connected to light emitting elements of the plurality of photosensors, respectively; and
an input port commonly connected to light receiving elements of the plurality of photosensors;
wherein the controller outputs signals having duty ratios corresponding to the plurality of photosensors to the light emitting elements in order through the plurality of output ports, respectively, and
the controller receives data input from the input port during a period in which the signals are output as an output of a photosensor as a detection target in the plurality of photosensors.

3. The photosensor driving device according to claim 2, further comprising
a single resistance connected between the light emitting elements and a ground when a maximum value and a minimum value of an output current of each of the light receiving elements are within a range of ±50% of a standard value of the output current predetermined as a characteristic of each of the light receiving elements.

4. The photosensor driving device according to claim 1, wherein
the light receiving elements are connected to a power supply which constantly supplies power thereto.

5. The photosensor driving device according to claim 2, wherein
the light receiving elements are connected to a power supply which constantly supplies power thereto.

6. A printer comprising a photosensor driving device according to claim 1.

7. A printer comprising a photosensor driving device according to claim 2.
